(19) United States
(12) Patent Application Publication
(10) Pub. No.: US 2001/0028965 A1
(43) Pub. Date: Oct. 11, 2001

(54) Tank for a carbon- and hydrogen-containing fluid

(76) Inventors: Stefan Boneberg, Beuren (DE); Martin Karl, Neidlingen (DE); Thomas Roser, Dettingen/Teck (DE); Martin Schussler, Ulm (DE); Detlef Zur Megede, Kirchheim/Teck (DE); Klaus Harth, Altleiningen (DE); Markus Holzle, Kirchheim (DE); Michael Sprague, Mannheim (DE)

Correspondence Address: CROWELL & MORING LLP, Intellectual Property Group, P.O. Box 14300, Washington, DC, 20044-4300, US

(21) Appl. No.: 09/741,909

(22) Filed: Dec. 22, 2000

(30) Foreign Application Priority Data
Dec. 24, 1999 (DE) 199 62 947.1

(51) Int. Cl. H01M 8/04; B60L 11/18; B65D 88/12

(52) U.S. Cl. 429/12; 180/65.3; 220/562; 220/565

(57) ABSTRACT

A tank for receiving a carbon- and hydrogen-containing fluid for supplying a fuel cell system with an operating medium has an inlet and an outlet for the fluid and at least one straining means for the fluid arranged between the inlet and the outlet.

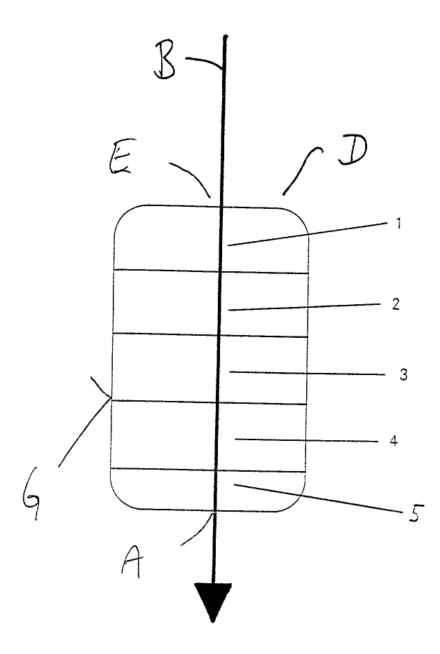

### BACKGROUND AND SUMMARY OF INVENTION

This application claims the priority of German application No. 199 62 947.1, filed Dec. 24, 1999, the disclosure of which is expressly incorporated by reference herein.

The present invention relates to a tank and use of the tank for receiving a carbon- and hydrogen-containing fluid for supplying a fuel cell system.

It is known to operate various systems with different fluids as operating media, such as for example fuel cells with methanol. In a fuel cell system, hydrogen is obtained from the operating medium and is made to react with oxygen under controlled conditions in the fuel cell. The electrical power obtained in this way can be used by electric loads.

Liquid operating media offer a high storage density for hydrogen. In particular when fuel cells are used in non-stationary systems, such as vehicles for instance, there are restrictions both with respect to the space available and with respect to safety considerations regarding the transportation and/or storage of relatively large volumes of hydrogen gas. Similarly, it is necessary in particular for fuel cell vehicles to ensure that operating media, in particular hydrogen, is supplied over an adequately widely covered area.

A major advantage of using operating media such as methanol or other carbon- and hydrogen-containing fluids is that methanol, for example, can be made available at filling stations with much less cost than hydrogen gas.

Prototypes of fuel cell vehicles are operated with media of chemically high purity (for example methanol or dimethyl ether) because undesired additives in the operating medium are easily entrained and can contaminate chemically active regions in the fuel cell system. On the other hand, in the commercial operation of fuel cell vehicles, which can be filled with such an operating medium at filling stations, a higher degree of contamination of the operating medium than is acceptable with the various chemically active regions of the fuel cell system must be expected because of the customary transport routes and transport methods.

In DE 198 47 985, there is a description of a tank for an operating medium of fuel cell vehicles in which a filtering means for methanol is used.

It is the object of the present invention to provide a tank for carbon- and hydrogen-containing fluids which is also suitable for fluids of low purity.

The tank according to the present invention for receiving a carbon- and hydrogen-containing fluid has an inlet and an outlet for the fluid, with at least one straining means for the fluid, which is intended for cleaning the fluid, being arranged between the inlet and the outlet.

The straining means is preferably formed from a composite body which has at least two zones of different permeability, at least for constituents of the fluid.

The advantage is that contaminants which get into the fluid as a result of production and/or transport are removed. It is particularly advantageous that specific contaminants can be selectively removed.

The tank may be used for cleaning liquid carbon- and hydrogen-containing media; alcohols, preferably methanol; hydrocarbons; and ethers, preferably dimethyl ether.

In a preferred use of the tank for cleaning an operating medium in a fuel cell system, preferably in a fuel cell vehicle, the catalytic components contained in the system (e.g., reformers, CO oxidators and/or the fuel cell) are protected against catalyst contamination. Furthermore, metallic components such as pipelines, heat exchangers and the like are protected against corrosive contaminants, thereby prolonging their service life. Furthermore, operating costs can be saved, since the prices for operating media of commercial purity are considerably lower than for media with the necessary high purity.

Avoidance of possible clogging of lines and passages is to be regarded as a further advantage. For instance, evaporators usually have narrow channels, which can easily be clogged by contaminants.

A further preferred use of the tank concerns use in a filling installation for fuel cell vehicles. In this case, cleaned or at least precleaned operating medium can be filled into a vehicle operated indirectly or directly on this operating medium.

Other objects, advantages and novel features of the present invention will become apparent from the following detailed description of the invention when considered in conjunction with the accompanying drawings.

### BRIEF DESCRIPTION OF THE DRAWING

The figure shows a schematic representation of a tank according to the present invention.

### DETAILED DESCRIPTION OF THE DRAWING

The present invention is described below for a preferred tank for carbon- and hydrogen-containing fluids which are used as operating media for fuel cells, particularly preferably for methanol as the fluid. However, the present invention is not restricted to this operating medium, but can also be used for other operating media. In particular, the tank is also suitable for water and/or a water/methanol mixture. The tank may be used for liquid and gaseous fluids. The tank is preferably used for carbon-containing hydrogen carriers, particularly preferably for those which also have oxygen, for example, alcohols, hydrocarbons, ethers, or esters.

The tank G represented in the figure has as straining means D a cleaning means for a fluid B. Fluid B represents an operating medium, for example for a fuel cell system. The straining means D is preferably formed by a composite body E, which is made up of various zones 1, 2, 3, 4, 5. The straining means D has the operating medium B flowing through it in this sequence. The direction of flow of the operating medium B is indicated by an arrow. The zones 1, 2, 3, 4, 5 preferably take up in each case constituents separated from the fluid B.

Each zone 1, 2, 3, 4, 5 is of different permeability for different constituents of the operating medium B. The composite body E preferably has at least two such zones, but may also have more zones. The zones preferably have adsorbers.

In a particularly preferred tank G for methanol as the operating medium, zone 1 of the straining means D is a particle filter; zone 2 is a filter for hydrocarbons; zone 3 is a filter for higher alcohols, ketones, esters and dimethyl ether; zone 4 is a filter for chlorides; and zone 5 is a filter for sulphur compounds. The sequence of the zones may of course also deviate from that described.

Preferred materials for the removal of hydrocarbons and higher alcohols, ketones, esters and dimethyl ether are activated carbon and/or zeolites. Preferred materials for the removal of chlorides are copper oxide and/or other metal salts and/or ion exchange resins.

Particularly troublesome contaminants in fuel cell operating media such as methanol are particles, paraffinic hydrocarbons, chlorinated hydrocarbons and inorganic chlorine compounds, more broadly hydrogen halides and inorganic halogen compounds, higher alcohols, dimethyl ether, esters, ketones, sulphur compounds and additives (flame colorants, coloring agents, odour-imparting agents).

Particularly preferred adsorber materials which are suitable for use in a tank G are activated carbon; copper oxide; zeolitic molecular sieves; surface-rich metal oxides, for example SiO₂, MgO, ZnO or else other metal oxides; and ion exchange resins.

A further preferred tank G has as straining means D a single zone, which is formed from a mixture of different adsorber materials.

A further refinement of the tank is that of equipping at least one zone of the straining means D with a membrane on which or in which a chemical conversion from a substance mixture to the desired operating medium can take place. A molecular sieve may be used in particular for this purpose.

It is also possible to combine various configurations of the straining means D with one another in one tank G.

It is particularly favourable to use the tank G for an operating medium of a fuel cell system. In an embodiment according to the present invention, the tank G has an inlet for a medium, a first outlet, and a second outlet. The tank G is subdivided by at least one straining means at least into an interior space on the inlet side and an interior space remote from the inlet. The first outlet is arranged in the interior space on the inlet side and the second outlet is arranged in the interior space remote from the inlet.

Use of such a tank as an operating medium tank in a fuel cell vehicle or as an operating medium tank in a filling installation for fuel cell vehicles is particularly favourable.

It is also preferred to arrange a tank G directly in a fuel cell system, such as for instance in a fuel supply line ahead of an evaporator for evaporating the liquid operating medium. Such a cleaning means is expediently fitted on the inflow side, with respect to the direction of flow of the operating medium, ahead of those components that are to be protected against contaminants.

Contaminated methanol is passed through the straining means D of the tank. As this happens, the contaminants are captured in the filter or straining means D by adsorption and/or filtration. Cleaned methanol leaves the straining means D.

One particular advantage is that cleaning of the operating medium can preferably take place in a fuel cell vehicle. Alternatively, corresponding cleaning of the operating medium may also take place directly at filling stations, for example in dispensing pumps. In particular in the case of methanol as the operating medium, hydrocarbons are extracted as contaminants and can advantageously be passed on locally for further use in motor fuels.

When a tank according to the present invention is used, for example in a fuel cell vehicle or some other system, the catalytic components contained in the fuel cell system, such as for instance reformers, CO oxidators and/or the fuel cell, are protected against catalyst contamination. Furthermore, metallic components such as pipelines, heat exchangers and the like are protected against corrosive contaminants, prolonging their service life. Furthermore, operating costs can be saved, since the prices for operating media of commercial purity are considerably lower than for media with the necessary high purity.

The tank G according to the present invention preferably has an indicator, which indicates the filling level of the straining means D, such as for instance “full” or “empty”. It is particularly expedient if the straining means D is exchangeably arranged, so that a fresh straining means D can be inserted when required at certain changing intervals and/or in accordance with a filling-level indication.

The tank G is preferably used to clean an operating medium of hydrocarbons and chlorine compounds, in particular chlorine salts. Chlorine especially is troublesome in a fuel cell system, since it accelerates the sintering of copper-containing catalysts in reforming units of the fuel cell system in an undesired way. In this case, amounts of contaminants of as little as about 10 ppb are harmful to the catalyst.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A tank for receiving a carbon- and hydrogen-containing fluid for supplying a fuel cell system with an operating medium, comprising:
a tank having an inlet and an outlet for the fluid;
at least one straining means for cleaning the fluid arranged between the inlet and the outlet.

2. A tank according to claim 1, wherein the straining means comprises at least one zone having regions of different permeability for constituents of the carbon- and hydrogen-containing fluid.

3. A tank according to claim 1, wherein the straining means comprises a composite body having at least two zones of different permeability for constituents of the carbon- and hydrogen-containing fluid.

4. A tank according to claim 2, wherein the at least one zone is an adsorber.

5. A tank according to claim 2, wherein the at least one zone is a particle filter.

6. A tank according to claim 2, wherein the at least one zone is a chemical converter for at least one constituent of the fluid.

7. A tank according to claim 2, wherein the at least one zone comprises a mixture of adsorber materials.

8. A tank according to claim 1, wherein the straining material comprises at least one adsorber material selected from the group consisting of activated carbon, copper oxide, a zeolitic molecular sieve, a metal oxide, and an ion exchange resin.

9. A tank according to claim 2, wherein the at least one zone comprises a membrane that is semipermeable at least for one constituent of the fluid.

10. A tank according to claim 1, wherein the straining means comprises a molecular sieve.

11. A tank according to claim 2, wherein the at least one zone is a ceramic body.

12. A tank according to claim 1, wherein the straining means is exchangeable.

13. A tank according to claim 1, further comprising a filling-level indicator for the straining means.

14. A method for cleaning a carbon- and hydrogen-containing fluid comprising feeding the fluid through a tank having at least one straining means for cleaning the fluid arranged between an inlet and an outlet.

15. A method according to claim 14, wherein the carbon- and hydrogen-containing fluid is methanol.

16. A method according to claim 14, wherein the carbon- and hydrogen-containing fluid is dimethyl ether.

17. A fuel cell vehicle comprising a tank according to claim 1.

18. A filling station for fuel cell vehicles comprising a tank according to claim 1.
